(19) United States
(12) Patent Application Publication
(10) Pub. No.: US 2011/0048695 A1
(43) Pub. Date: Mar. 3, 2011

(54) MANIFOLD AND SYSTEM FOR SERVICING MULTIPLE WELLS

(75) Inventors: Boris (Bruce) P. CHEREWYK, Calgary (CA); Jerry JOHNSON, Red Deer (CA)

(73) Assignee: ISOLATION EQUIPMENT SERVICES, INC., Red Deer (CA)

(21) Appl. No.: 12/939,051

(22) Filed: Nov. 3, 2010

Related U.S. Application Data
(60) Provisional application No. 61/257,838, filed on Nov. 3, 2009.
(60) Provisional application No. 61/258,555, filed on Nov. 5, 2009.

(51) Int. Cl. E21B 19/00; B23P 17/00

(52) U.S. Cl. 166/90.1; 29/402.08

(57) ABSTRACT

A manifold for distribution of well servicing fluids, such as fracturing fluids, to a plurality of wells. The manifold has a single bore through which the fluid flows and a plurality of outlets which are connected to the bore. Two or more of the outlets deliver the fluid to each wellhead. Valves are positioned in each of the outlets so that each of the wellheads can be independently isolated from the fluids for selecting which of the wells will be serviced at any given time. A total cross-sectional area of the outlets feeding each of the wells is greater than the cross-sectional area of the bore which results in a velocity reduction in the outlets which reduces erosion in the manifold and the downstream components Systems are described using prior art manifolds or manifolds according to embodiments of the invention for use specifically with fracturing fluids containing proppant. Proppant can be delivered to the fracturing fluid through the manifold, directly to the wellhead or both, to reduce erosion. Use of a manifold according to embodiments of the invention, in combination with the systems described, are particularly useful for reducing erosion with proppant-laden fracturing fluids.

### FIELD OF THE INVENTION

Embodiments of the invention relate to servicing multiple wells with a fluid and, more particularly, to manifolds and valving therein for selectively accessing the wells and further to minimize the erosive effects of stimulation fluids therein.

### BACKGROUND OF THE INVENTION

There are an increasing number of subterranean hydrocarbon reservoirs which are accessed using multiple wells for optimizing production therefrom. The wells and wellheads connected thereto are often closely spaced, the wellbores being angled downwardly and radially outwardly to access as much as the reservoir as possible.

Many or all of multiple pay zones in such reservoirs may be characterized by low permeability or other characteristics which require stimulation of one or more of the wells for increasing production therefrom. During selective stimulation of the wells, which may include fracturing operations performed on one well, wireline operations may be also be performed on other wells, such as to shift wellbore access from one zone to another zone. To consolidate pumping equipment, such as pumpers and proppant supply for use in fracturing, a large common manifold has been employed to connect a fracturing fluid inlet selectively to one or more of the wellheads of the multiple wells. Thus, multiple wells can be stimulated simultaneously with multiple trains of pumpers and manifolds.

Prior art manifolds are characterized by a plurality of adjacent flow blocks forming a single main manifold having a large bore for connecting fluid delivery lines to each wellhead. Large, full bore gate valves are located inline with the manifold bore between each adjacent flow block for isolating the adjacent flow blocks from one another. For example, for a manifold having a 7 inch bore, 7 inch valves, typically gate valves, are spaced inline between each adjacent flow block, fit flange to flange with ring seals and bolted together. Thus, when a valve or a seal is leaking, it is challenging and cumbersome to manipulate the single large manifold sufficiently to arrange to lift the compromised valve clear of the manifold. Further, it is difficult to part the flanges and remove, service and replace the compromised valve and ring seals without causing damage to the seals.

The need to maintenance the manifold and valves is exacerbated by the erosive nature of stimulation fluids flowing therethrough during stimulation operations. The stimulation fluids typically have high fluid flow rates caused to flow at high velocity from the single large bore manifold through like-sized outlets. The high velocity flow results in significant wear to the manifold and manifold valves, as well as to downstream equipment.

The addition of proppant, such as sand, to fracturing fluids is known to cause severe erosion. Generally, the proppant is added to the fracturing fluid at the pumpers and thus upstream equipment, such as the fluid pumpers, are also vulnerable to the erosive effects of the proppant-laden fracturing fluids passing therethrough.

Currently, it is known and common to stockpile replacement manifold components, including new flow blocks and valves, onsite and ready for replacement as the job proceeds. It is also known to have replacement fluid pumpers on standby to assume stimulation fluid delivery while active pumpers are taken offline for refurbishing. On large jobs, it is not uncommon to have ten or more pumpers on site, the redundancy required to maintain simultaneous and continuous stimulation despite the increased costs.

The flexibility of selection of wells which can be serviced by the prior art manifold is compromised by the valves located inline in the bore of the manifold. Wells can only be serviced in series. Once a gate valve has been closed in the bore to isolate a well, all of the wells fluidly connected to the manifold downstream of the closed gate valve are also isolated. Therefore should one wish to service wells which are remotely fluidly connected from one another it may not be possible to do so without delivering fluids to the intervening wells.

There is clearly a need in the industry for more cost effective and robust apparatus and methods for the delivery of stimulation fluids selectively to multiple wells and to improve the flexibility with which wells may be selected.

### SUMMARY OF THE INVENTION

Embodiments of the present invention are directed to an apparatus, system and method of selectively servicing two or more wells concurrently. A fluid, such as a fracturing fluid is pumped from pumping units through a manifold that is fluidly connected to the two or more wells. The velocity of the fluid is reduced as the fluid travels from the pumping unit to the manifold and is further reduced as the fluid travels from the manifold to each of the two or more wells. The reduction of the velocity of the fluid reduces the erosive effects of the fluid on the manifold and other equipment, prolonging the operational life thereof.

In a broad aspect of the invention, a manifold for delivering a fluid for selectively servicing two or more wells has a manifold body having a live bore formed therethrough, the live bore having a live bore cross-sectional area. An inlet is fluidly connected to the live bore for receiving the fluid therein. Two or more distributors are also fluidly connected to the live bore for distributing the fluid to each of the two or more well. Each distributor has two or more outlets fluidly connected to one well of the two or more wells for delivery of fluids thereto, and each outlet has an outlet bore with an outlet cross-sectional area. Valves are positioned in each outlet bore of the two or more outlets for selectively isolating the fluid from one or more of the two or more wells. The total outlet cross-sectional area for each of the two or more distributors is greater than the live bore cross-sectional area for reducing the velocity of the fluid in the two or more outlets.

In another broad aspect of the invention, a system for servicing two or more wells accessing a formation, the wells having wellheads attached thereto, has a manifold, a source of a fluid, fluidly connected to the inlet; and fluid connections between the two or more outlets of each of the two or more distributions blocks and one wellhead of the two or more wells. The manifold can comprise a bore formed therethrough for receiving a fracturing fluid, an inlet fluidly connected to the bore for delivering the fracturing fluid to the bore, two or more outlets fluidly connected to the bore, at least one outlet fluidly connected to one of the two or more wells, and valves operatively connected between the manifold bore and each of the one or more wells for isolating the fracturing fluid from one or more of the two or more wells.

The system pumps the fluid from the fluid source to the manifold, the fluid flowing unimpeded through the main bore of the manifold block for delivery to the two or more outlets of each of the two or more distribution blocks.

When two or more valves of one or more of the two or more distribution blocks are actuated to an open position, the fluid flows through the main bore is delivered to the one or more wells fluidly connected thereto, and when the two or more valves of one or more of the two or more distribution blocks are actuated to a closed position, the one or more wells fluidly connected thereto are isolated from the fluid flowing through the main bore.

In another broad aspect of the invention, a method for replacing or repairing a valve in a manifold for selectively accessing two or more wells, the manifold having two or more distribution flow blocks, each distribution flow block fluidly connected to a main manifold bore and having two or more outlets fluidly connected to one well of the two or more wells for delivery of fluids thereto, each outlet having an outlet bore and a valve removeably secured thereto, involves discontinuing flow of fluid to the manifold bore, disconnecting the removeable connectors between the outlet and the valve, reconnecting a new or repaired valve to the outlet; and reestablishing the flow of fluid to the manifold bore.

### BRIEF DESCRIPTION OF THE FIGURES

FIG. 1A is a schematic representation of a prior art system including at least one pumper for delivering fluid to a prior art manifold fluidly connected to two or more wells;

FIG. 1B is a schematic representation of a manifold according to an embodiment of the invention;

FIG. 2 is a more detailed longitudinal, partial sectional view of the manifold of FIG. 1B, gate valves having been removed from facing outlets for clarity;

FIG. 3 is an exploded partial cross-sectional view according to FIG. 2 illustrating a distribution flow blocks, a receiving flow block and flanged connectors for connecting therebetween;

FIG. 4 is a longitudinal partial cross-sectional view of the manifold of FIG. 2, illustrating a common contiguous live bore and outlets fluidly connected thereto for delivery fluid to multiple wellheads;

FIG. 5 is a cross-sectional view of the receiving flow block of FIG. 3, illustrating inlets for receiving from a fluid source;

FIG. 6 is a cross-sectional view of the distribution flow block of FIG. 3, illustrating outlets for fluidly connecting to a wellhead;

FIG. 7 is a cross-sectional view of the flanged connector of FIG. 3;

FIG. 8 is a cross-sectional view of an end distribution flow block, illustrating three outlets and an inline flow connection for connection to a second manifold or for release of fluid from the live bore;

FIG. 9 is a schematic representation of a main manifold and two slave manifolds according to an embodiment of the invention;

FIG. 10 is a partial cross-sectional view of a slave manifold according to FIG. 9;

FIG. 11 is a schematic site layout of the prior art system of FIG. 1A in use for a fracturing operation and having pumpers, a sandbox for providing proppant and blenders for adding and mixing the proppant to the fracturing fluid before delivery to the prior art manifold;

FIG. 12A is a schematic site layout of an embodiment of a system having pumpers, proppant supply and blenders for a multi-well stimulation system, the erosive proppant being provided in a proppant supply system parallel to the high rate of fracturing fluids from the fluid system, the proppant supply and fluid systems combining at the wellhead;

FIG. 12B is a schematic site layout of an embodiment of a system having pumpers, proppant supply and blenders for a multi-well stimulation system, the erosive proppant being provided in a first concentration to the fracturing fluid and being provided in a second concentration, different that the first concentration, in a parallel proppant only supply system, the first and second concentrations combining at the wellhead;

FIG. 13A is a schematic site layout of an embodiment wherein a fracturing fluid pumping unit is fluidly connected to a main manifold and a slave manifold for delivering fracturing fluid using a first fluid path, and a slurry pumping unit fluidly connected directly to a wellhead for delivering a slurry of proppant and fluid using a second fluid flow path;

FIG. 13B is a partial side cross-sectional view of the embodiment of FIG. 11A, illustrating fracturing fluid entering the fracturing head in opposing arrangement while the proppant slurry is delivered inline with a radial axis of the fracturing head; and

FIG. 14 is a schematic site layout of an embodiment wherein the slurry pumping unit is capable of servicing two wellheads concurrently.

### DETAILED DESCRIPTION OF THE INVENTION

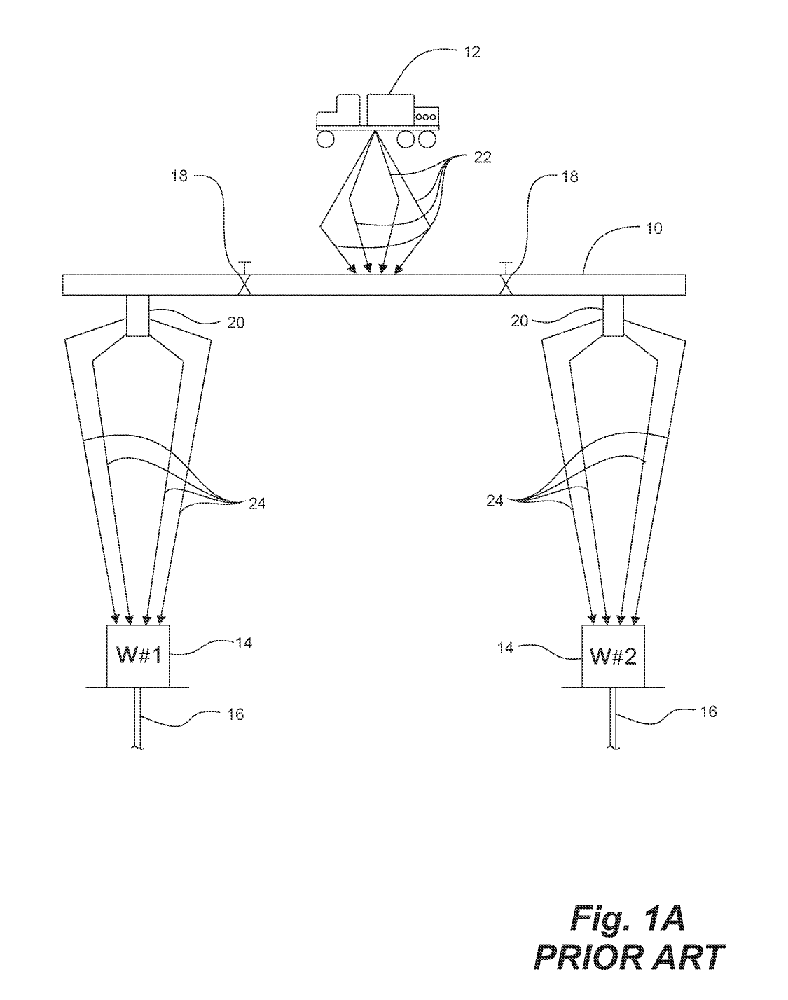

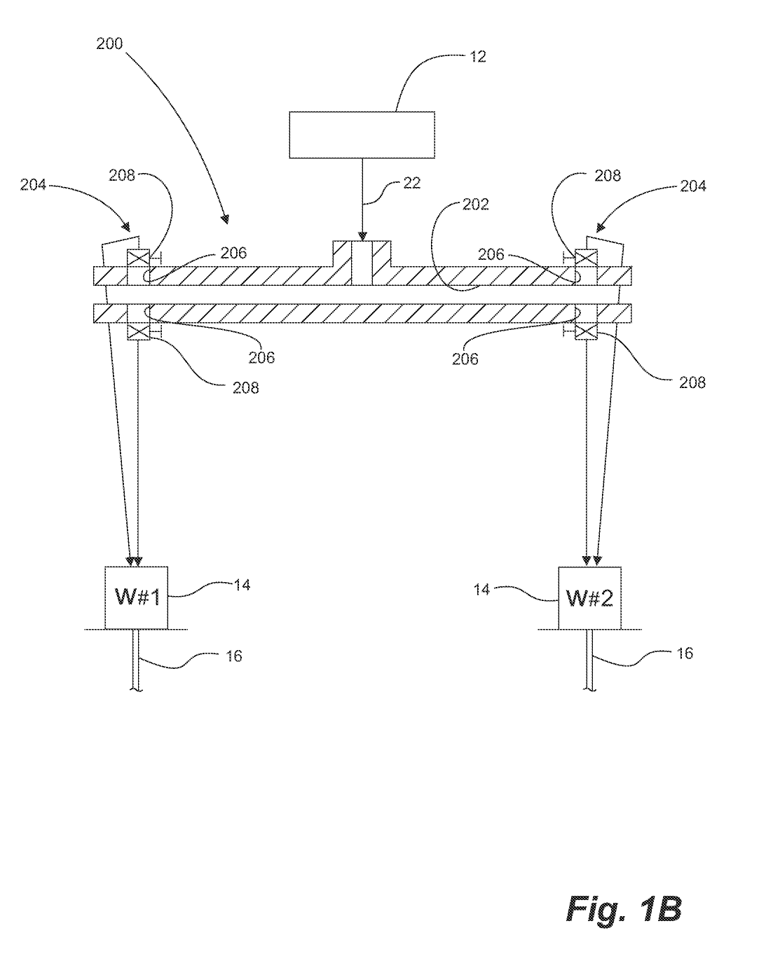

As shown in FIG. 1A, in a prior art multi-well stimulation operation, a prior art manifold 10 is utilized for fluidly connecting one or more stimulation fluid sources 12, typically pumpers, to a wellhead 14 of each of a plurality of wells 16 so as to permit selectively accessing two or more of the wells 16 concurrently. The prior art manifold 10 comprises a plurality of large, full-bore sized inline gate valves 18 therein for isolating selected wells 16. The manifold 10 receives the stimulation fluid from the one or more pumpers 12 at high velocity for selective delivery through large outlets 20, maintaining the high velocity of the fluid delivered therefrom, to the selected wells 16. Applicant notes that when one or more of the gate valves 20 are closed for isolating any of the wells 16 from the manifold 10, any wells 16 fluidly connected downstream from the closed gate valve 18 are isolated. Thus, selection of wells 16 to be serviced is not flexible. Further, it has been noted that erosion occurs in both the valves 18 and the manifold 10, particularly as the high velocity, high flow rate fluid turns to exit at high velocity from large diameter outlets 20.

In the prior art, to lessen the fluid velocity and rate of erosion, the combined pumping capacity, typically from the plurality of pumpers 12, was routed through a plurality of parallel fluid supply lines 22 (four shown) to the manifold 10. The gate valves 18 dividing the manifold bore were then closed or opened selectively for isolating some wellheads 14 and for directing fluids to others. To lessen the fluid velocity and rate of erosion associated therewith, a plurality of parallel fluid delivery lines 24 (four shown) were connected from the outlets 20 to the wellhead 14. Applicant notes however that the parallel delivery lines 24 do not significantly reduce erosion that occurs at the connection of the large diameter outlets 20 to the large diameter manifold 10.

As shown in FIG. 1B, embodiments of the invention utilize a manifold 200 having a manifold body 201 which comprises an open, live bore 202 formed therethrough. Distributors 204 comprising two or more outlets 206 are fluidly connected to the live bore 202 for fluid connection to each wellhead 14. As described in greater detail below, the two or more outlets 206 in each distributor 204 have a total outlet cross-sectional area which is greater than a cross sectional area of the live bore 202 for reducing the velocity of the fluid at the outlets 206. Further, valves 208 for isolating the wells are positioned in each of the outlets 206. The valves 208 in the outlets 206 are therefore not only subjected to lower velocity flows for reducing wear, but are also positioned outside the manifold's live bore 202 for easier access for maintenance, repair or replacement. This is particularly advantageous when the stimulation fluid is a fracturing fluid carrying a proppant, which is highly erosive at the high velocity.

An additional advantage of positioning the valves 208 in the outlets 206 is that there is greater flexibility in selecting wells 16 for servicing. As each well 16 is independently connected to the live bore 202 of the manifold 200, one or more wells 16 can be isolated from the manifold bore 202 and the fluids therein without affecting the delivery of fluid to any of the other wells 16.

Further, as each outlet 206 can have a cross-sectional area which is smaller than a cross-sectional area of the manifold bore 202, the valves 208 therein can also be reduced in size. Smaller valves are easier to remove for repair or replacement. Typically, the valves 208 are connected to the outlets 206 through removable connectors such as flanged connections 207.

When valves 208 require removal for replacement or repair, the flow of fluid to the live bore 202 is discontinued. The removable connections 207 between the outlet 208 and the valve 208 to be removed are disconnected and the valve 208 is removed. Thereafter, a new valve 208 or a repaired valve 208 is provided at the outlet 206 and the removable connectors 207 reconnected therebetween. Once the valve 208 has been replaced, the flow of fluids is reestablished through the live bore 202. Typically, the manifold 200 is pressure tested following replacement of the valve 208 to ensure the manifold 200 is capable of withstanding stimulation pressures.

While embodiments of the invention are suitable for delivery of a variety of stimulating fluids, embodiments of the invention are generally described herein in the context of a fracturing operation. Particular advantages are obtained when using embodiments of the invention for delivering fracturing fluids which comprise a particulate proppant P therein.

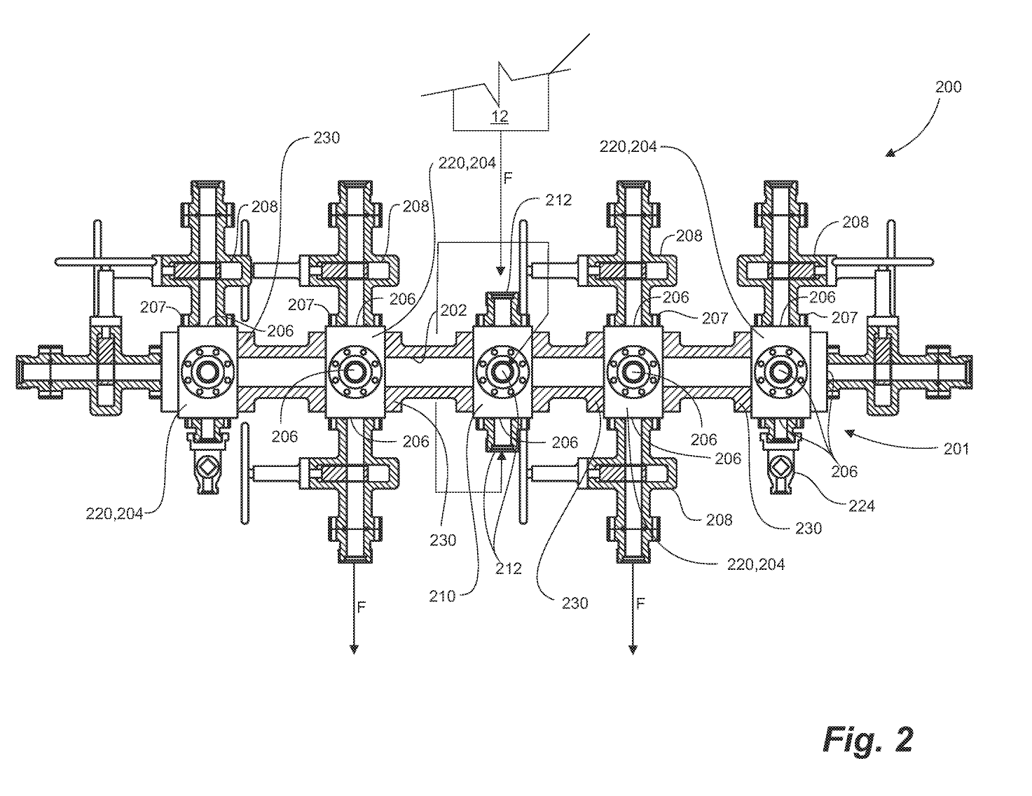

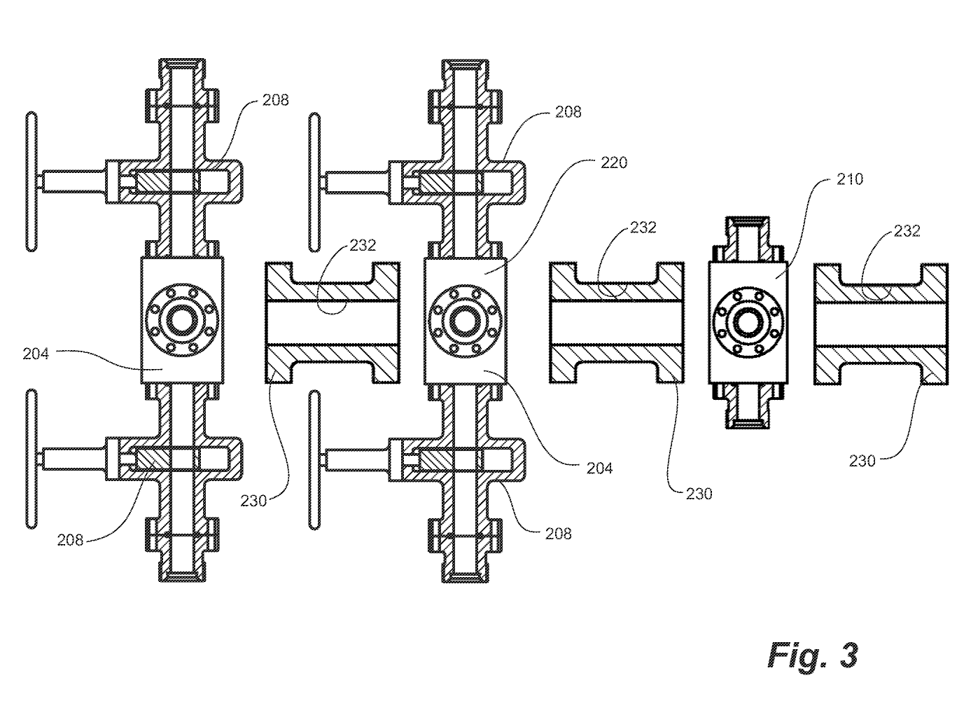

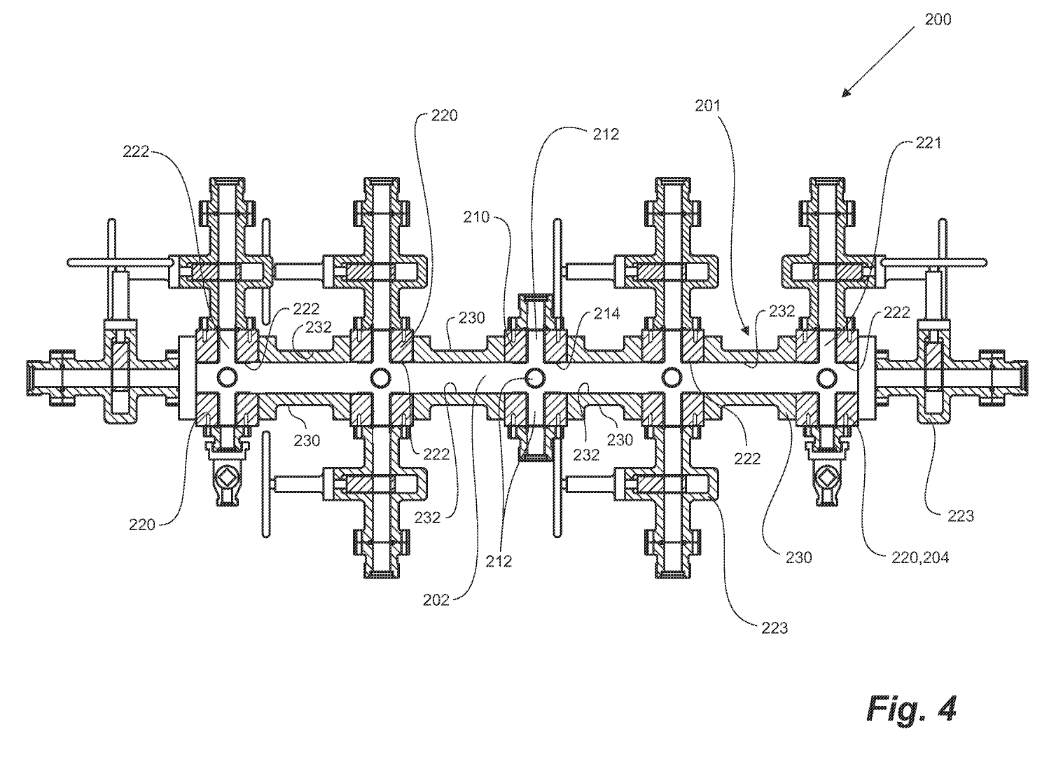

In greater detail, as shown in FIGS. 2-4, a body 201 of the manifold 200 comprises a receiving flow block 210 having one or more inlets 212 for receiving a fracturing fluid F from the fluid source 12, such as a pumping unit. The receiving flow block 210 has a bore 214 formed therethrough to which the one or more inlets 212 are fluidly connected. The manifold body 201 further comprises two or more distribution flow blocks 220, each of the distribution flow blocks having a bore 222 formed therethrough and comprising one of the two or more distributors 204 having the two or more outlets 206 fluidly connected to the bore 222. The bore 214 of the receiving flow block 210 and the bores 222 of the distribution flow blocks 220 are fluidly connected to one another for forming the live bore 202.

In embodiments the flow blocks are connected using flanged connectors 230, each of the flanged connectors 230 having a bore 232 formed therethrough for forming the live bore 202.

Together, the receiving flow block 210, the distribution flow blocks 220, and the flanged connectors 230 structurally form the manifold body 201.

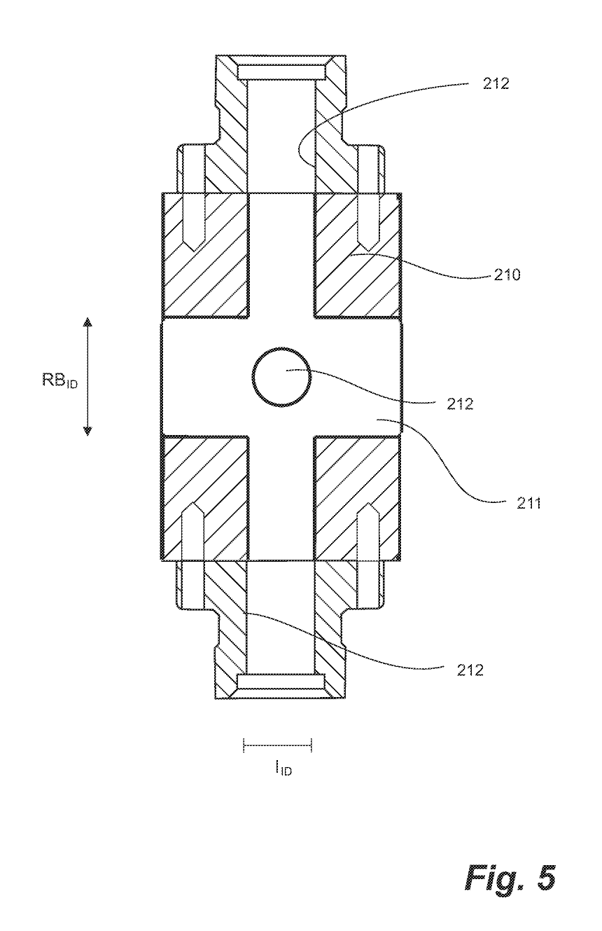

With reference to FIG. 5, and in greater detail, in an embodiment the receiving flow block 210 comprises the receiving bore 214 extending longitudinally therethrough. The one or more inlets 212 which extend radially from the receiving bore 214 comprise four inlets 212 positioned in an opposing arrangement. That is, each inlet 212 is positioned directly opposite another inlet 212 so that fracturing fluid F incoming through the opposing inlets 212 will impinge for reducing the velocity of the fluid F. The reduction in velocity further aids in reducing the erosive effects of the fracturing fluid F within the manifold 200 and downstream equipment.

The receiving bore 214 has an internal diameter RB_{ID} defining a total cross-sectional area RB_{XA}. Each of the one or more inlets 212 has an internal diameter I_{ID}, defining an inlet cross-sectional area I_{XA}. The total cross-sectional area of the longitudinal receiving bore RB_{XA} is greater than the total combined inlet cross-sectional areas I_{XA} for reducing the velocity of the fracturing fluid F entering the receiving bore 214.

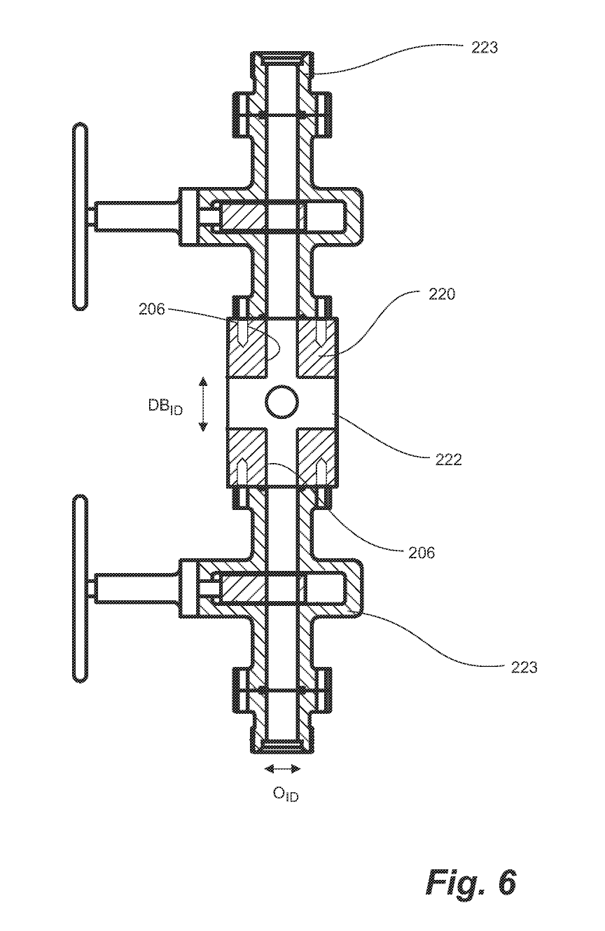

With reference to FIG. 6, each distribution flow block 220 has a corresponding longitudinal distribution bore 222 having an internal diameter of DB_{ID}. The one or more outlets 206 extending radially outwardly from the distribution bore 222 comprise four outlets 206. Each outlet 206 has an internal diameter O_{ID} defining an outlet cross-sectional area O_{XA}. A total combined outlet cross-sectional area O_{XA} is greater than the live bore cross-sectional area LB_{XA}. Accordingly, as the fracturing fluid F travels from the relatively smaller live bore cross-sectional area LB_{XA} into the relatively larger outlet cross-sectional area O_{XA}, the velocity of the fracturing fluid F decreases.

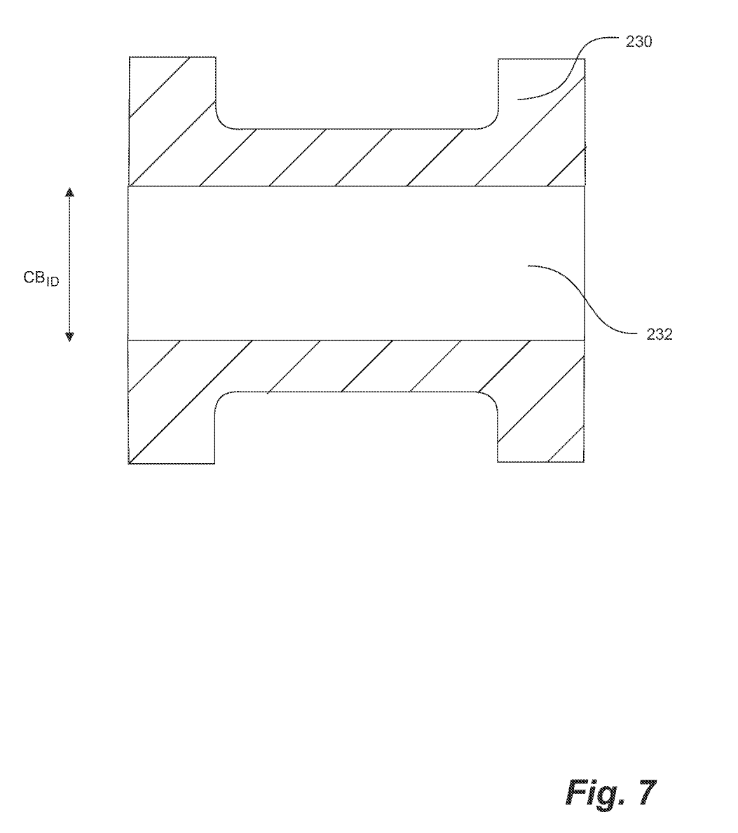

With reference to FIG. 7, the longitudinal connector bore 232 of the connector 230 has an internal diameter CB_{ID}. In an embodiment, the internal diameter CB_{ID} of the connector bore 232 is substantially the same as the internal diameter DB_{ID} of the distribution bore 222 and the internal diameter RB_{ID} of the receiving bore 214 to minimize areas where erosion may occur.

The connector bore 232, the receiving bore 214 and the distribution bores 222, form the common, contiguous live bore 202 having a cross-sectional area LB_{XA}.

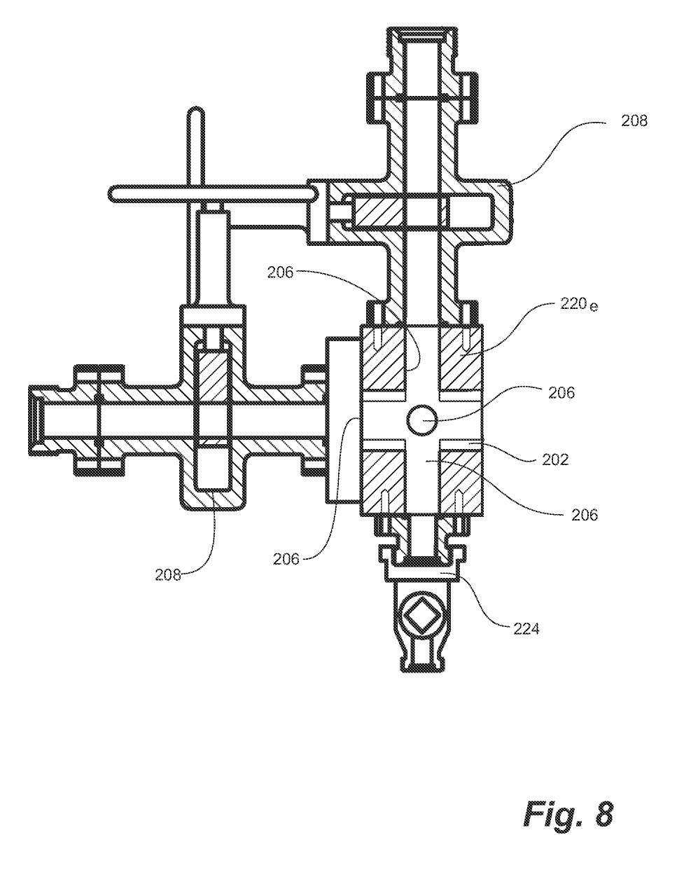

In an embodiment, as shown in FIG. 8, in distribution blocks 220e positioned at opposing ends of the manifold 200, one of the outlets 206 comprises an inline flow connection 224 for discharging up to about 25% of the fracturing fluid within the live bore 202 for minimizing wear and erosion.

As one of skill in the art will appreciate, the velocity of the fracturing fluid F, as it travels at an initial pumping velocity from the pumpers 12 through the inlets 212 to the larger cross-sectional receiving flow bore 214, is reduced. Thereafter as the fluid F travels from the distribution flow blocks 220 and to the total larger cross-sectional area of the outlets 206, the velocity is reduced again. The cumulative reduction in velocity of the fracturing fluid F minimizes the erosive effects of the abrasive fracturing fluid F on the manifold 200 and on other downstream well equipment.

For example, a typical 7 inch fracturing flow system, uses 7 inch inlet flow lines 212 to the inlet receiving block 210 having a total inlet cross-sectional area I_{XA}, of about 39 square inches. Four—4 1/16 inch outlet lines 206 from the distribution flow block 220 have an outlet cross-sectional area O_{XA} of about 13 square inches per outlet 2106, or a total outlet cross-sectional area O_{XA} of about 52 square inches.

Applicant believes that the smaller valves 208, such as 4 inch valves, fit within the smaller, individual outlets 206 are more reliable than the large prior art valves. Embodiments of the invention permit use of the smaller, more reliable valves 208, yet permit a total outlet cross-sectional area O_{XA} greater than that of the common contiguous live bore 202 permitting velocity reduction.

Table 1 summarizes typical velocity reductions observed according to embodiments of the invention.

TABLE 1
FLUID VELOCITIES (FT/SEC) IN VARIOUS I.D.'s

| VALVE DIA. | VEL. © 4 M³/MIN. | VEL. © 5 M³/MIN. |
|---|---|---|
| 7 1/16″ | 8.6 FPS | 10.8 FPS |
| 4 1/16″ | 26 FPS | 32.5 FPS |

| VALVE DIA. | VEL. © 3 M³/MIN. |
|---|---|
| 3 1/16″ | 34.3 FPS |
| MANIFOLD I.D. | VEL. © 16 M³/MIN. |
| 7 1/16″ | 34.4 FPS |

NOTES:
EACH WELL FED BY 4 LINES
EACH MANIFOLD FED BY 4 LINES
MANIFOLD IS 7 1/16″ DIA.
ALL VALVES ARE 4 1/16″ DIA
ALL LINES ARE 4 1/16″ DIA
PRESSURE RATING IS 10,000 PSI
QUICK CHANGE OF ALL PARTS

As shown, the velocity of a fracturing fluid F entering a 7 1/16″ diameter live bore 202 of the manifold 200, through four 4 1/16″ inlet lines 212 at an initial pumping velocity of 16 cubic meters per minute (m3/min), is reduced from the initial pumping velocity to 34.4 feet per second (fps) in the live bore 202.

In a manifold 200 having fracturing fluid F flowing through the live bore 202 therein at 3 m³/min and four outlets 206 at each distribution block 220, each outlet 206 and valve 208 therein having a diameter of 3 1/16″, the velocity at each of the four outlets 206 is 34.4 fps.

In a manifold 200 having fracturing fluid F flowing through the live bore 202 therein at 4 m³/min and four outlets 206 at each distribution block 220, each outlet 206 and valve 208 therein having a diameter of 4 1/16″, the velocity at each of the four outlets 206 is 26 fps. If the outlet 206/valve 208 diameter is increased to 7 1/16″, the velocity is reduced to 8.6 fps.

In a manifold 200 having fracturing fluid F flowing through the live bore 202 therein at 5 m³/min and four outlets 206 at each distribution block 220, each outlet 206 and valve 208 therein having a diameter of 4 1/16″, the velocity at each of the four outlets 206 is 32.5 fps. If the outlet 206/valve 208 diameter is increased to 7 1/16″, the velocity is reduced to 10.8 fps.

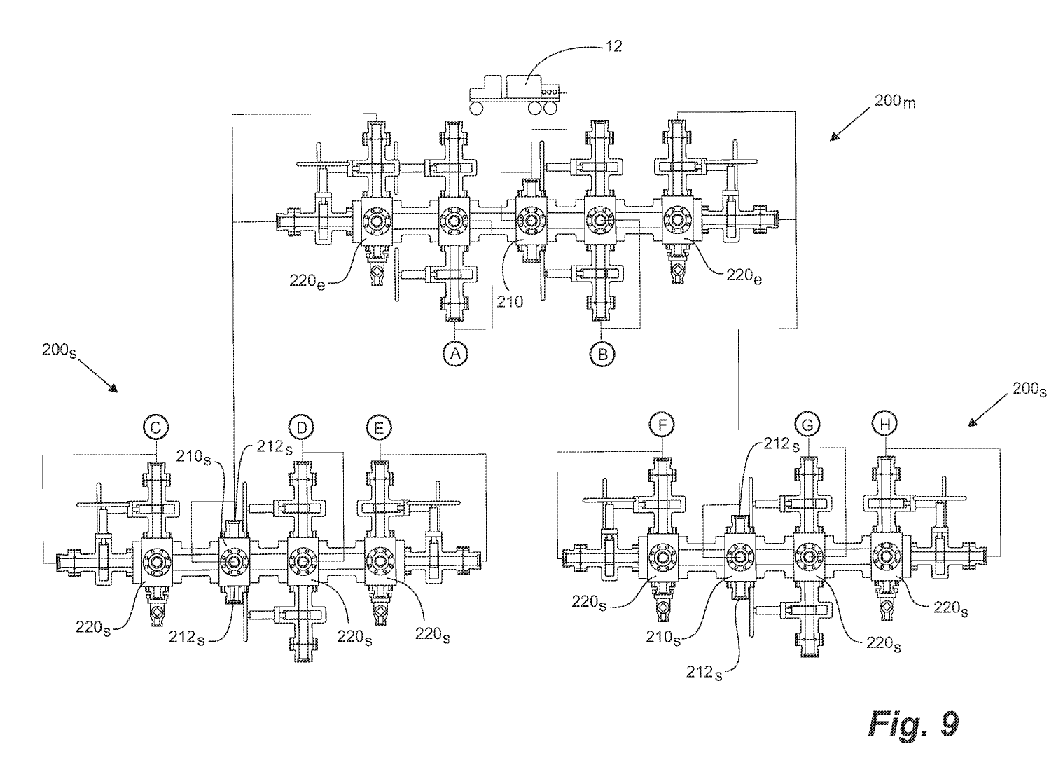

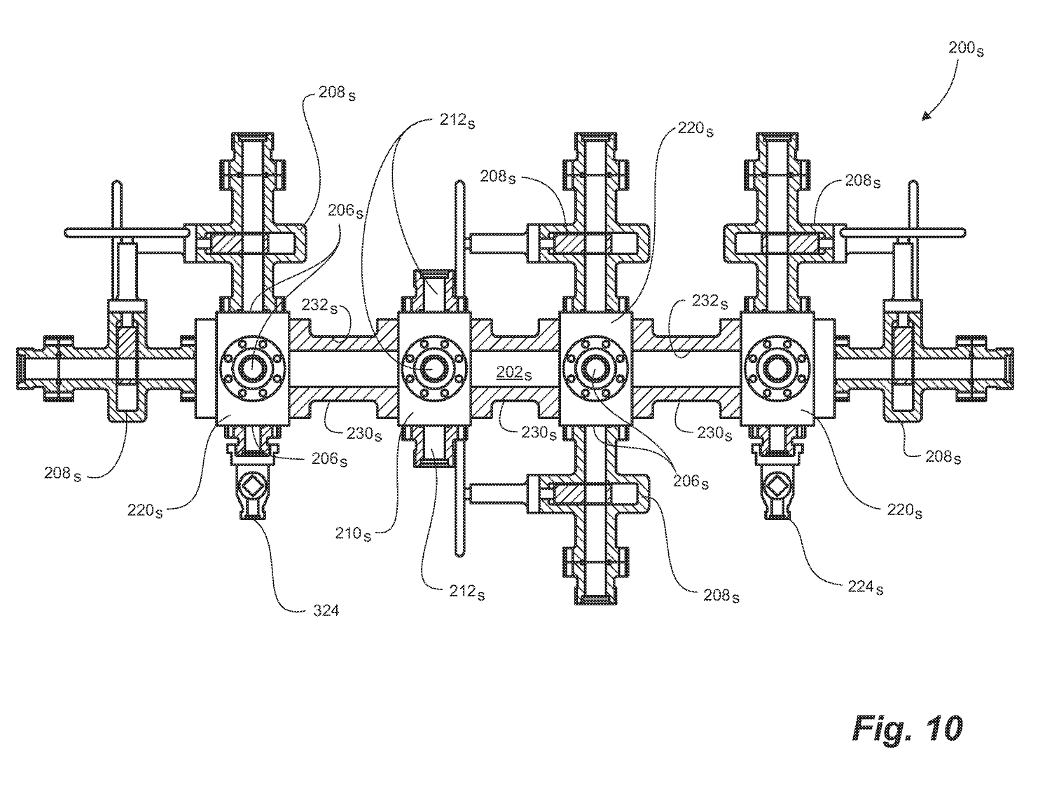

Having reference to FIGS. 9 and 10, in an embodiment, the manifold 200 further comprises a main manifold 200m, fluidly connected to one or more slave manifolds 200s. The one or more slave manifolds 200s are substantially identical in structure to the main manifold 200m, having a slave receiving block 210s fluidly connected to the main manifold 200m for receiving fracturing fluid F therefrom. Two or more slave distribution blocks 220s, each comprising two or more slave distributors 204 having two or more slave outlets 206s, deliver fracturing fluid F to two or more of the plurality of wells 16. The slave manifold 200s has a live bore 202s formed therethrough as described for the main manifold 200m. In an embodiment, the slave receiving block 210s is fluidly connected to and receives fracturing fluid F at slave inlets 212s from one or more of the outlets 206 of end distributions blocks 220e of the main manifold 200m.

As shown in FIG. 9, as an example, the system is capable of being fluidly connecting to eight wellheads 14, labeled A-H, for servicing using the main manifold 200m and two slave manifolds 200s. The eight wells 16 can be stimulated simultaneously, depending on pumper capability or isolated independently for stimulation or for servicing as necessary, such as for replacing lines or changing a zone for the next fluid treatment.

In embodiments, each of the main and slave manifolds 200m, 200s can be shorter in length, the overall manifold system being capable of servicing the same number of wells 16 as would be serviced using a single, large manifold 200. Advantageously, the shorter length manifolds 200m, 200s are particularly suited to sites where space constraints are an issue.

Having reference again to FIGS. 8, 9 and 10, the inline flow connection 224 from the end distribution blocks 220e positioned at opposing ends of the main manifold 200m and the slave manifolds 200s, besides having the advantage of providing a discharge from the live bores 202m, 202s of the main and slave manifolds 200m, 200s, also provide a convenient drain/bleed or methanol access point.

### Fracturing Operations

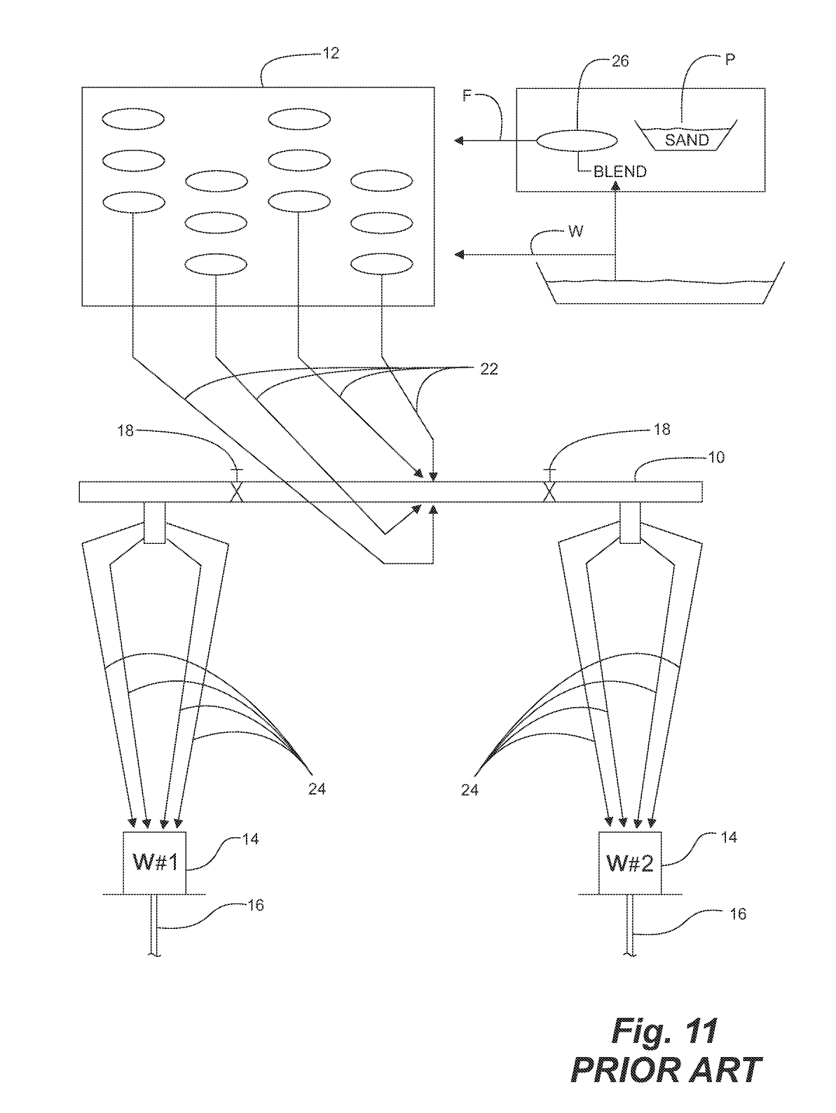

Having reference to FIG. 11, a prior art system of delivering a fracturing fluid F to a plurality of wells 16 as shown in FIG. 1A, incorporates a prior art manifold 100. Proppant P, such as sand from a sandbox, is conveyed to one or more blenders 26 for mixing with fluid W, usually water from local sources at ambient conditions. The proppant-laden fluid F is delivered to the plurality of pumpers 12 for pressurizing to stimulation pressures. To lessen fluid velocity and the rate of erosion, the combined pumping capacity is routed through the parallel fluid supply lines 22 (four shown) to the prior art manifold 10. From the manifold 10, valves 18 dividing the manifold 10 are opened for directing fracturing fluids F and proppant P contained therein to the selected wellhead 14 or closed for isolating a wellhead 14 or wellhead 14 downstream therefrom from the fracturing fluid F. Again, for lessening fluid velocity and the rate of erosion, the fracturing fluid F is also routed through parallel fluid delivery lines 24 (four shown) to the wellhead 14.

In embodiments of the invention, issues related to the erosive nature of the proppant P present in stimulation fluids, such as fracturing fluids F, are minimized using systems and methodology for delivery thereof. As one of skill in the art will appreciate, while embodiments of the invention are described herein using a manifold 200 according to an embodiment of the invention to achieve the combined benefits thereof, the systems and methods described can also be practiced using prior art manifolds 10.

Utilizing systems and methods according to embodiments of the invention, proppant P can be delivered directly to the wellheads 14 for mixing with fluid F at the wellheads 14, can be delivered to the pumpers 12 for forming the fracturing fluid F therein for delivery to a manifold 10, 200 for subsequent delivery to the wellheads 14 or can be delivered to both the manifold 200 and the wellheads 14 for mixing at the wellheads 14.

In the case where proppant P is delivered to the pumpers 12 for delivery to the manifold 200, the fracturing fluid F is delivered as described for the prior art as shown in FIG. 1A. Use of the novel manifold 200 according to embodiments of the invention, results in decreases in velocity of the proppant-laden fluid F flowing therethrough and through downstream equipment for reducing erosion therein as previously described and discussed.

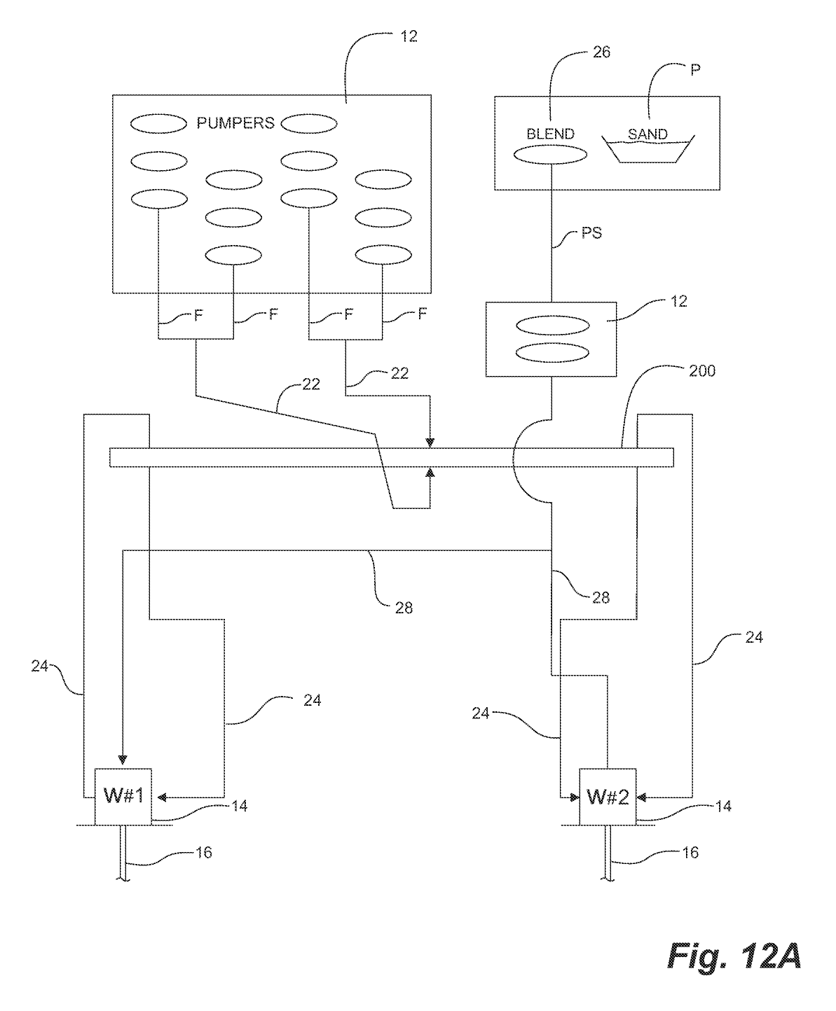

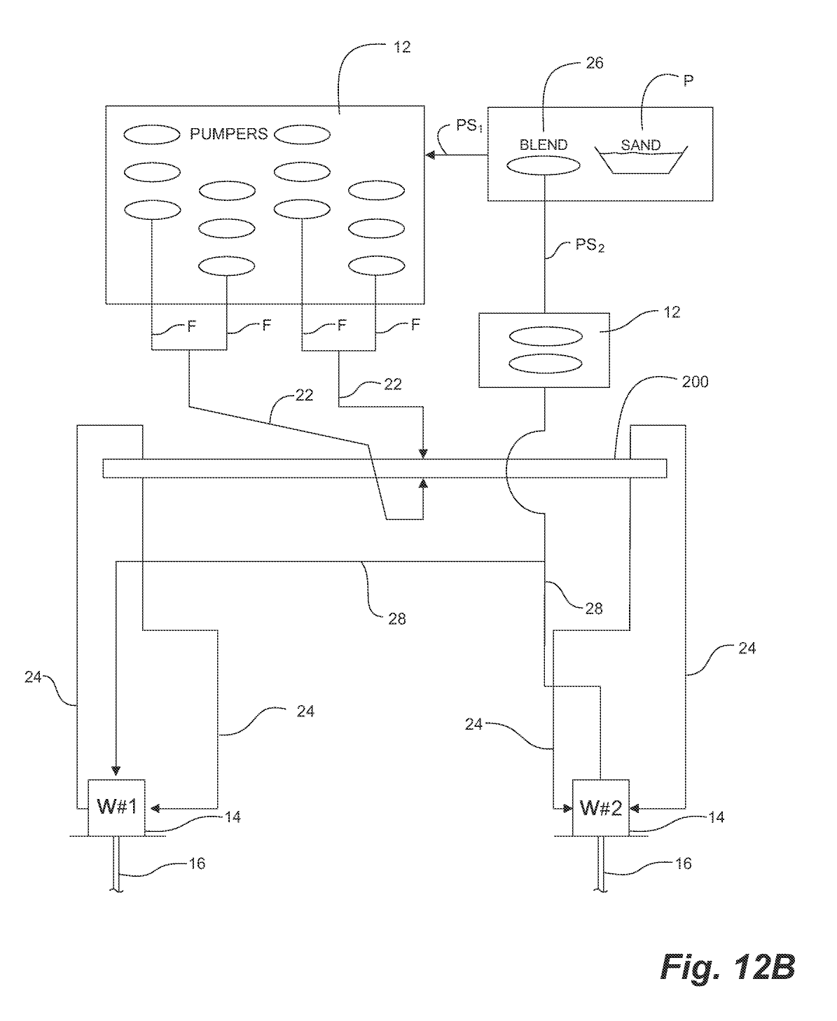

As shown in FIG. 12, in the case where proppant P is delivered directly to the wellheads 14 for mixing with the fluid F, the proppant P is blended with a fluid W, typically water for forming a proppant slurry PS. The proppant slurry PS is delivered to one or more proppant pumpers 12p, designated for proppant use, for pressurizing to stimulation pressures. The proppant slurry PS is thereafter delivered through delivery lines 28 to the wellheads 14. Simultaneously, fracture fluid F, absent proppant P, is pressurized in a plurality of pumpers 12 for delivery to the manifold 200 and to the wellheads 14 as previously described.

Embodiments which deliver proppant slurry PS directly to the wellheads 14 eliminate any erosion in pumpers 12, in the manifold 200 and in the valves 108 in the manifold outlets 206. The proppant pumpers 12 however are placed at higher risk for erosion of pumping equipment therein.

In an embodiment of the invention, proppant P is provided to both the fluid pumpers 12 and to the proppant pumpers 12p. In this embodiment, proppant P is provided to the fluid pumpers 12 at a first concentration PS₁ and is provided to the proppant pumpers 12p at a second concentration PS₂ which is higher than the first concentration. The fracturing fluid F with proppant P and the proppant slurry PS are mixed at the wellheads 14 to a final concentration or design load of proppant P for delivery to the wells 16.

In embodiments, the first proppant concentration PS₁ is lower than concentrations which result in significant erosion and thus, the fluid pumpers 12 can last much longer before servicing, unlike in the prior art where servicing is typically performed periodically during well stimulation.

Further, as the fracturing fluid F flowing through the manifold 200 and downstream components is less erosive, the rate of flow can be increased without increased erosion. With increased flow rates, the number of flow lines required to deliver the same volume of fracturing fluid F can be decreased.

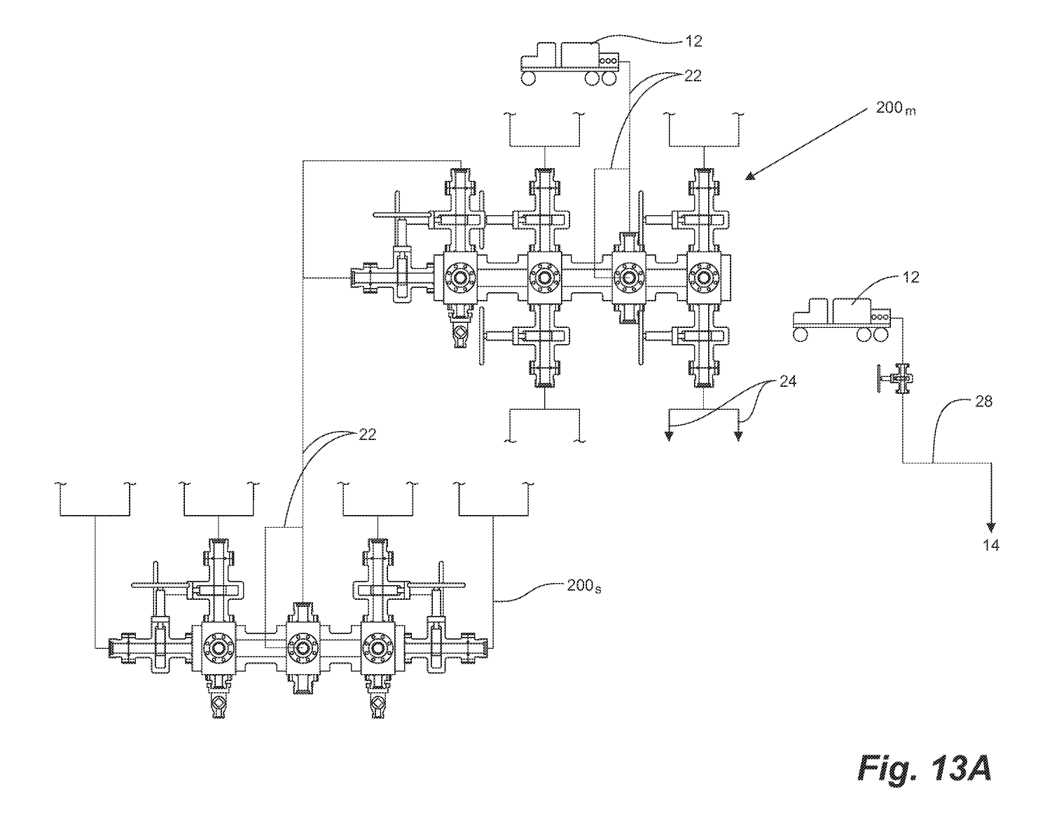

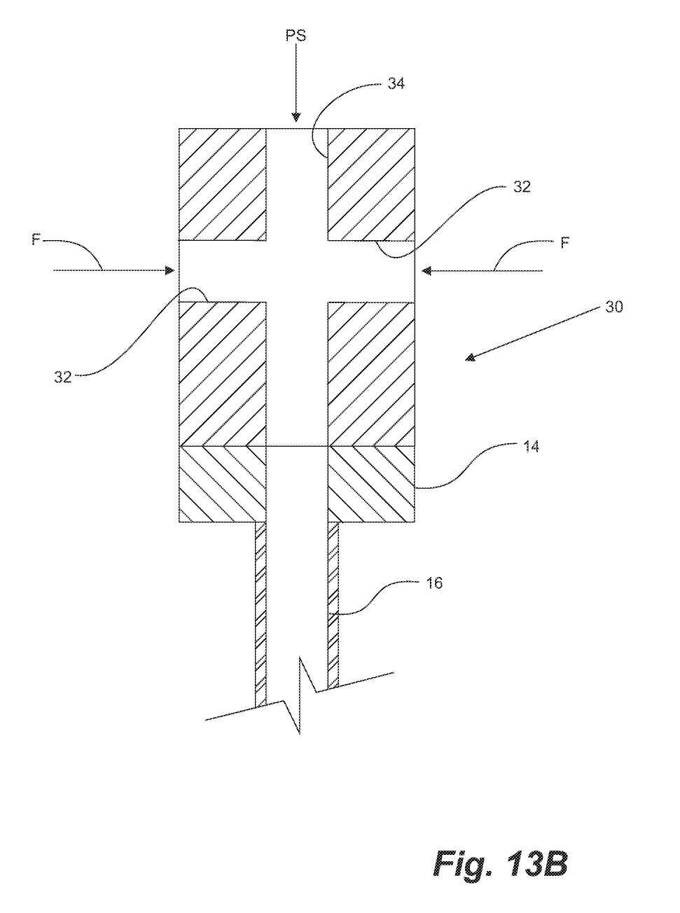

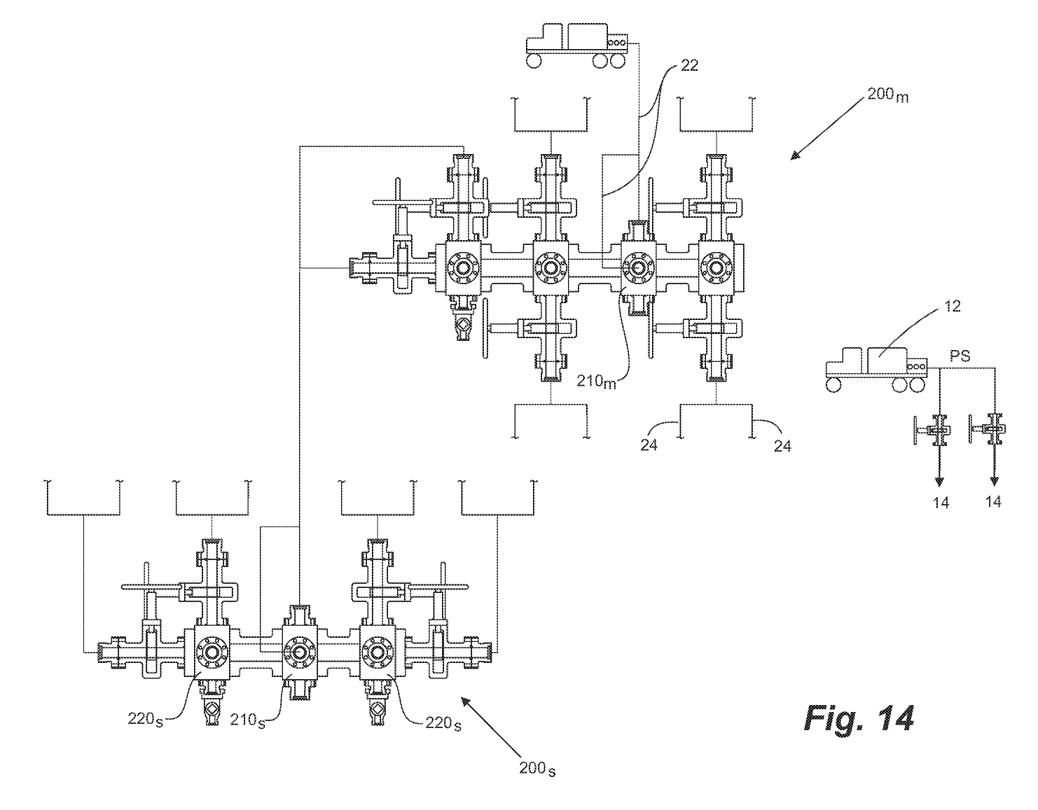

FIGS. 13A and 14, illustrate a reduced number of supply lines 22 from the pumping unit 12 to the main manifold 200m and from the main manifold 200m to a slave manifold 200s. Further, the fluid delivery lines 24 from the main manifold 200m and the slave manifold 200s to the wellheads 14 can also be reduced. In an embodiment as shown, two supply lines 22 and two delivery lines 24 are used through which fluid flows at twice the volumetric throughput as the previously described embodiments. In the case shown in FIG. 13A, proppant slurry PS is provided through a single supply line 28 directly to a single wellhead 14 and in the case of FIG. 14, proppant slurry PS is provided through two supply lines 28, directly to two wellheads 14.

Accordingly, embodiments which utilize only two fluid delivery lines 22 to the wellheads 14 utilize only two outlet ports 206 and two valves 208 in each distribution flow block 220. The remaining outlets 206 remain unused and can be fit with valves 208 which are closed to isolate the outlets 206 or alternatively the outlets 206 can be plugged. Alternatively, the distributions blocks 220 can be manufactured having fewer outlets 206 for this purpose. The reduction of flow lines 22,24 required to conduct fracturing fluid from the pumping units 12 to the well 16 contribute to reducing capital expense, faster setup, faster pressure testing, due in part to fewer components and connections, and a reduction in equipment clutter onsite.

As shown in FIG. 13B, at a selected wellhead 14, fracturing fluid F, without proppant P or at the first proppant concentration PS₁, is injected from the manifold 200 through delivery lines 24 into a fracturing head 30 in the wellhead 14 through inlets 32 on opposing sides of the fracturing head 30. The opposing arrangement acts to cause the fluid streams to impinge and absorb energy before the fracturing fluid F is directed downhole by the fracturing head 30.

Where the proppant slurry PS is provided to the wellhead 14 from the proppant pumpers 12p through delivery line 28, either at the full design concentration or at the second concentration PS₂, the proppant slurry PS from the proppant pumpers 12p is added to a port 34 of the fracturing head 30 to combine with the fracturing fluid F injected therein through the opposing inlets 32. The net result is that the design load of proppant P is provided in the overall combined fluid flow downhole.

For example, two 4-inch fluid delivery lines 24 from the manifold 200 coupled to opposing inlets 32 at the fracturing head 30 can deliver the fracturing fluid F from the manifold 200 at a flow rate of about 7 m³/min. Proppant slurry PS, at concentrations of up to 800 kg/m³, pumped from the proppant pumpers 12p through a single 3-inch delivery line 28 connected to the port 34 of the fracturing head 30, delivers the proppant slurry PS at a flow rate of about 3 m³/min, which is substantially less than the flow rate of the fracturing fluid F. In embodiments, the port 34, is inline with a bore of the fracturing head 30 and thus minimizes even further any erosive effects at the fracturing head 30.

Applicant is aware that the concentration of proppant PS₂ in the proppant slurry PS might be four times the concentration of proppant PS₁ in the fracturing fluid F and yet remain pumpable. Where the proppant pumpers 12p pump proppant slurry PS having a high concentration of proppant P, the velocity is reduced. Further, as the high concentration proppant slurry PS contains very low fluid levels, it is not responsible for providing operational levels of fracturing fluid F. Thus, it becomes feasible to expend energy to warm up the smaller amounts of ambient water used to prepare the proppant slurry PS to enhance chemical mixing during the preparation of the proppant slurry PS at the blender 26.

The embodiments of the invention for which an exclusive property or privilege is claimed are defined as follows:

1. A manifold for delivering a fluid for selectively servicing two or more wells comprising:
a manifold body having a live bore formed therethrough, the live bore having a live bore cross-sectional area;
an inlet fluidly connected to the live bore for receiving the fluid therein;
two or more distributors, each distributor being fluidly connected to the live bore, each distributor having two or more outlets fluid connected to one well of the two or more wells for delivery of fluids thereto, each outlet having an outlet bore with an outlet cross-sectional area; and
a valve positioned in each outlet bore of the two or more outlets for selectively isolating the fluid from one or more of the two or more wells,
wherein the total outlet cross-sectional area for each of the two or more distributors is greater than the live bore cross-sectional area for reducing the velocity of the fluid in the two or more outlets.

2. The manifold of claim 1 further comprising:
two or more inlets fluidly connected to the live bore for receiving the fluid therein, each of the two or more inlets having an inlet bore with an inlet cross-sectional area and total inlet cross-sectional areas is less than the live bore cross-sectional area for reducing the velocity of the fluid in the live bore.

3. The manifold of claim 1 wherein the cross-sectional area of each of the outlet bores is less than the live bore cross-sectional area for reducing the size of the valves located therein, each of the valves having a valve cross-sectional area.

4. The manifold of claim 3 wherein the valve cross-sectional area in each of the two or more distributors is greater than the live bore cross-sectional area.

5. The manifold of claim 1 wherein the manifold block further comprises:
a receiving flow block having a receiving bore formed therethrough, the inlet being fluidly connected to the receiving bore; and
two or more distribution flow blocks, each distribution flow block comprising one of the two or more distributors and having a distribution bore formed therethrough; and
wherein the receiving bore and the distribution bore of each of the two or more distribution flow blocks are arranged for forming the contiguous live bore, the total outlet cross-sectional areas for each of the two or more distribution flow blocks being greater than a cross-sectional area of the live bore.

6. The manifold of claim 5 wherein the receiving flow block and the two or more distribution blocks are connected using removable connections.

7. The manifold of claim 5 wherein the receiving flow block comprises:
two or more inlets fluidly connected to the receiving bore for receiving the fluid therein, each of the two or more inlets having an inlet bore with an inlet cross-sectional area, the total inlet cross-sectional area being less than the manifold live bore cross-sectional area for reducing the velocity of the fluid in the manifold live bore.

8. The manifold of claim 5 wherein each bore of the receiving flow block and the two or more distribution flow blocks has a substantially identical inner diameter for reducing erosion therein.

9. The manifold of claim 6 wherein inner diameters of the outlet bore, a valve bore and a bore through the removable connections are substantially identical for reducing erosion therein.

10. The manifold of claim 7 wherein at least two of the two or more inlets are positioned directly opposite one another, fluid entering therethrough being caused to impinge for reducing the velocity in the live bore.

11. The manifold of claim 7 wherein one of the two or more outlets of one of the two or more distribution flow blocks further comprises:
a discharge flow connection for discharging fluid therefrom for reducing velocity in the live bore.

12. A system for servicing two or more wells accessing a formation, the wells having wellheads attached thereto, the system comprising:
a manifold having
a bore formed therethrough for receiving a fluid;
an inlet fluidly connected to the bore for delivering the fluid to the bore;
two or more outlets fluidly connected to the bore, at least one outlet fluidly connected to one of the two or more wells; and
valves operatively connected between the bore and each of the one or more wells for isolating the fluid from one or more of the two or more wells,
a source of the fluid, fluidly connected to the inlet; and
a fluid connection for fluidly connecting between the at least one outlet with a wellhead of one of the two or more wells,
wherein when the fluid is pumped from the fluid source to the manifold, the fluid flows unimpeded through the bore of the manifold for delivery to the two or more outlets, and
when the valves are selectively actuated to an open position, the fluid flowing through the manifold is delivered to the one or more wells fluidly connected thereto; and
when the valves are selectively actuated to a closed position, the one or more wells fluidly connected thereto are isolated from the fluid flowing through the manifold.

13. The system of claim 12, wherein the fluid is a fracturing fluid, further comprising;
a fracturing head fluidly connected to the wellhead of each one of the two or more wells, the fracturing fluid from the manifold being delivered to the fracturing head when the valves of the manifold connected thereto are actuated to an open position.

14. The system of claim 13 further comprising:
a source of a proppant slurry for addition to the fracturing fluid; and
one or more fluid connections between the source of proppant slurry and the fracturing head of each of the two or more wellheads for mixing the fluid and the proppant slurry at the fracturing head.

15. The system of claim 14 wherein the proppant slurry is delivered to the fracturing head at a flow rate lower than a flow rate at which the fracturing fluid is delivered to the manifold.

16. The system of claim 12 further comprising:
a first source of proppant slurry having a first proppant concentration;
a second source of particulate proppant slurry having a second proppant concentration being greater than the first proppant concentration;
one or more fluid connections between the first source of proppant slurry and the fluid source for mixing the fluid and the proppant prior to delivery to the inlet; and
one or more fluid connections between the second source of proppant slurry and the fracturing head of each of the two or more wellheads for mixing the fluid and first proppant slurry with the second proppant slurry at the wellhead.

17. The system of claim 16 wherein the fluid mixed with the first proppant slurry is delivered to the manifold at a first flow rate and the second proppant slurry is delivered to the wellheads at a second flow rate being lower than the first flow rate.

18. The system of claim 12 wherein the manifold further comprises:
a manifold body having a live bore therethrough, the live bore having a live bore cross-sectional area; and
two or more distributors, each distributor being fluidly connected to the live bore, and fluidly connected to one well of the two or more wells for delivery of the fluid, each distributor having two or more of the two or more outlets,
wherein the inlet is fluidly connected to the live bore for receiving fluid therein;
wherein each outlet further comprises an outlet bore with an outlet cross-sectional area;
wherein the valves are positioned in each outlet bore for selectively isolating the fluid from one or more of the two or more wells; and
wherein the total outlet cross-sectional area for each of the two or more distributors is greater than the live bore cross-sectional area for reducing the velocity of the fluid in the two or more outlets

19. The system of claim 18 further comprising:
one or more slave manifolds, each of the one or more slave manifolds having
a slave manifold having a slave bore formed therethrough, the slave bore having a slave cross-sectional area;
a slave inlet fluidly connected between an outlet of the main manifold and the slave bore for receiving the fluid therein;
two or more slave distributors, each slave distributor fluidly connected to the slave bore and having two or more slave outlets fluidly connected to one of the two or more wells for delivery of fluids thereto, each slave outlet having a slave outlet bore with a slave outlet cross-sectional area; and
slave valves positioned in each slave outlet bore for selectively isolating the fluid from one or more of the two or more wells,
wherein the sum of the slave outlet cross-sectional areas for each slave distributors is greater than the slave bore cross-sectional area for reducing the velocity of the fluid in the slave outlets.

20. A method for replacing or repairing a valve in a manifold for selectively accessing two or more wells, the manifold having two or more distribution flow blocks, each distribution flow block fluidly connected to a main manifold bore and having two or more outlets fluidly connected to one well of the two or more wells for delivery of fluids thereto, each outlet having an outlet bore and a valve removeably secured thereto, comprising:
discontinue flow of fluid to the manifold bore;
disconnect removeable connectors between the outlet and the valve;
reconnect a new or repaired valve to the outlet; and
reestablish the flow of fluid to the manifold bore.
